(19) United States
(12) Patent Application Publication
(10) Pub. No.: US 2006/0243555 A1
(43) Pub. Date: Nov. 2, 2006

(54) Multi-plate clutch

(76) Inventor: Leif Lewis, Valley Village, CA (US)

Correspondence Address: FULWIDER PATTON, 6060 CENTER DRIVE, 10TH FLOOR, LOS ANGELES, CA, 90045, US

(21) Appl. No.: 11/115,939

(22) Filed: Apr. 27, 2005

(51) Int. Cl. F16D 13/52

(52) U.S. Cl. 192/70.2

(57) ABSTRACT

A multi-plate clutch includes a plurality of friction plates that are rotationally coupled to a concentric shell wherein keys radially extending from each friction plate are slidably received in axial channels formed in the interior surface of the shell. The keys of all but one of the friction plates are dimensioned to have a relatively loose fit in the channels while the keys on a single friction plate are dimensioned to have a substantially tighter fit in the channels. This has a stabilizing effect on the entire stack without impeding the operation of the clutch. Rotational stabilization of the plates serves to dampen the impact of the edge of each of the keys of each of the plates against the channel sidewall during abrupt load changes in the drivetrain to thereby reduce wear and the generation of noise.

### BACKGROUND OF THE INVENTION

The present invention generally relates to multi-plate clutches and more particularly pertains to the extension of the service life of such devices as well as the reduction of the noise that is typically generated thereby.

Clutches are employed for interruptably coupling two rotating components to one another such as for example an engine to a transmission. A multi-plate clutch configuration offers significant advantages over a single-plate clutch configuration including the ability to accommodate a greater torque handling capability in an overall smaller package. As a consequence, such clutch configurations are found in a large variety of different applications including high-performance motorcycles and automobiles, trucks and heavy machinery. There are however some disadvantages associated with multi-plate clutch devices, including the propensity for the accelerated wear of its component parts and the noise that is caused by the interaction of the wearing parts.

In general terms, a multi-plate clutch employs a stack of drive plates and friction plates that are concentrically arranged in an alternating sequence along a common axis wherein one of the two sets of plates is keyed to an internally disposed shaft or carrier while the alternating set of plates is keyed to an externally disposed cylindrical shell or basket. Configurations in which the driving plates are steel and the driven plates are made of friction material as well as configurations in which the driving plates are made of friction material and the driven plates are steel are both well known in the art. When the stack is compressed, the plate faces engage to become rotationally joined to one another and are thereby able to effectively transfer torque from the shell to the shaft or from the shaft to the shell. In the absence of a compressive force, the plates disengage and are free to spin relative to one another thereby interrupting the transfer of torque between the external shell and the internal shaft.

In keying the one set of plates to the externally disposed shell, it is essential that the plates remain axially shiftable relative thereto while being rotationally locked thereto. Each plate must be capable of axially shifting slightly as the stack of plates is compressed so as to take up the slack between the plates which had allowed the alternating plates to freely spin relative to one another. Conversely, when the compressive force is released, the plates must be able to readily shake free from the adjacent plates in order to rotationally decouple the shaft from the shell. This is typically accomplished by forming axially extending channels in the externally disposed shell that are dimensioned to receive keys that are formed about the outer circumference of each plate. Each plate is thereby rotationally locked to the shell as one of the edges of each of the keys engages one or the other sidewall of the channel in which it resides while the keys are free to shift along the channels.

In order to ensure that the axial movement of the keys remains uninhibited under all operating conditions, the widths of the keys are typically selected to be slightly undersized relative to the widths of the channels. While this achieves the intended effect, it is the underlying cause of a number of shortcomings inherent in multi-plate clutches. The gap between the leading edge of each key and the sidewall of the channel allows the keys to slam into the respective channel sidewall with each change in the direction of torque transfer. This becomes especially problematic in automotive and motorcycle applications as such impacts will occur with every upshift and downshift, with every switch between accelerative loading and decelerative loading while in a gear and even when in neutral, as each firing pulse will cause the engine's output to undergo a brief acceleration and deceleration. These impacts not only generate noise and vibration, but cause the keys and/or channels to wear. Any such wear accelerates the rate of further wear along with a commensurate increase in noise and vibration as the impacts become harsher until the clutch becomes unserviceable.

A number of different approaches have heretofore been taken in effort to address the above-described problem inherent in multi-plate clutches. Reducing the tolerances between the keys and channels has generally been found to be of limited utility as the function of the clutch quickly becomes compromised. Close tolerances between the keys of each of the plates and the corresponding channels renders the keys prone to binding or jamming in the channels should the plates and/or associated keys become distorted, angled or otherwise misaligned. Such binding or jamming would prevent or delay the clutch from decoupling the driving and driven components when the compressive force is released thereby making it difficult to select neutral or shift gears. Conversely, binding or jamming could prevent or delay the clutch from effectively coupling the driving and driven components when the stack of plates is compressed. Most efforts have therefore focused on damping the impact of the leading edge of each key with the sidewall of the channel.

A well known approach entails the submersion of the entire clutch mechanism in a fluid wherein the fluid naturally fills any gaps and thereby serves to dampen the impact between a key and the sidewall. This is highly effective, greatly increases service life and reduces or even eliminates the noise. However, the oil used in so-called “wet” clutches introduces a significant amount of drag to thereby rob power and increase fuel consumption. Additionally, in four stroke motorcycle applications, such clutches tend to contaminate the engine oil.

An alternative approach entails the use of mechanical damping devices such as springs or O-rings that are fitted to or about the key/channel interface so as to buffer the impacts between the engaging surfaces. While such modifications have been found to be somewhat effective in reducing the impact loads and the associated noise and damage, the added components not only add complexity to the clutch mechanism but are more prone to failure. Damaged or broken metallic parts that come loose can cause further damage to the clutch and difficulty in its operation while broken O-rings can prevent plates from separating and shaking apart.

A multi-plate clutch configuration is needed that overcomes the shortcomings of presently known multi-plate configuration. It is most desirable to provide a multi-plate clutch that is not as prone to excessive wear rates, that does not generate noise during its operation and that does not suffer from the complexity of presently known efforts to address wear and noise.

### SUMMARY OF THE INVENTION

The present invention overcomes the shortcomings of previously known multi-plate clutches wherein the improved clutch configuration serves to substantially extend service life and to reduce the generation of noise during its operation. Such gains are realizable in dry as well as wet type applications.

The present invention generally provides for the differentiation of the rotational coupling of one of the drive plates of a multi-plate clutch to the shell or basket so as to have less rotational play than the other drive plates in the clutch pack. By limiting the rotational play of just one plate, the ability of the individual plates to shift axially as is required for the plates to disengage is preserved, while limiting the rotational play of such one plate greatly reduces the rotational play of all of the other plates when the plates are fully engaged.

In a preferred embodiment of the present invention, the multi-plate clutch includes a stack of drive plates and driven plates that are disposed in a conventional configuration to the extent that they are arranged in an alternating sequence along a common axis wherein one set of plates is keyed to an internally disposed shaft or carrier and the other set of plates is keyed to an externally disposed shell. Each of the plates that is keyed to the externally disposed shell includes a series of keys or tabs that extend radially therefrom and that are configured for receipt in axially extending channels that are formed along the interior surface of the shell. In accordance with the invention, one of the plates that is keyed to the externally disposed shell is similarly configured but differentiated in terms of its dimensions. Such dimensioning has a stabilizing influence on the positions and movements of the other plates while the stack of plates is under compression to thereby greatly reduce the force of the impacts of the keys against the channel walls.

The “stabilizer” plate of the present invention is differentiated from the other plates that are keyed to the externally disposed shell in that the dimensions of its keys are selected to much more closely coincide with the dimensions of the channel that is formed in the interior surface of the shell, i.e. with less rotational play, while the keys of all of the other plates are dimensioned to have a substantially looser fit, i.e. more rotational play within the channels as per conventional multi-plate clutch configurations. The unexpected result achieved by the present invention is that while the inclusion of one such stabilizer plate in the stack of drive plates achieves the desired rotational stability, it does not adversely affect the operation of the clutch. The stabilizing plate can be included anywhere in the sequence of plates but is most preferably positioned at either extreme end of the stack.

Upon compression of the stack of drive plates and driven plates, the stabilizer plate serves to stabilize the rotational position of all of the other plates in the stack relative to the channels in the shell. The minimal play between the keys of the stabilizer plate and the channels in which they are received substantially precludes relative rotation between the stabilizer plate and the shell. Because all of the other plates are frictionally linked to the stabilizer plate, any rotation relative to the stabilizer plate and therefore relative to the channels in the shell requires that such friction be overcome. Overcoming the friction requires a substantial amount of force which in turn greatly reduces the relative rotational velocity that can be achieved. The much reduced relative rotational velocity in turn greatly reduces the force with which the keys engage the sidewalls of the respective channels. This substantially reduces wear to the engaging surfaces and all but eliminates the generation of a hammering noise. The stabilizer plate may optionally be dimensioned to have a thickness greater than the thickness of the other drive plates in order to increase the surface area of each of the keys that contacts the sidewalls of the channels and thereby reduce wear to both the keys as well as the channel sidewalls.

Alternative configurations may be employed to rotationally couple the stabilizer plate to the shell so as achieve a smaller amount of rotational play. Rather than relying on slightly wider keys to engage the same channels formed in the shell as are engaged by the other drive plates, the shell may have a second set of channels dedicated exclusively for the receipt of the keys of the stabilizer plate. Alternatively, a separate pin and slot arrangement may be relied upon to achieve the desired restriction in rotational freedom. It is contemplated that other mechanisms may also be adapted to achieve the objectives of the present invention.

These and other features and advantages of the present invention will become apparent from the following detailed description of the preferred embodiments which, taken in conjunction with the accompanying drawings, illustrate by way of example the principles of the invention.

### BRIEF DESCRIPTION OF THE DRAWINGS

FIG. 1 is an exploded perspective view of a multi-plate clutch configuration of the present invention;

FIG. 2 is a transverse cross-sectional view taken along lines 2-2 in FIG. 1;

FIG. 3 is a transverse cross-sectional view taken along lines 3-3 in FIG. 1;

FIG. 4 is a longitudinal cross-sectional view of an alternative embodiment of the clutch of the present invention with the clutch pack in its compressed state;

FIG. 5 is a longitudinal cross-sectional view of another alternative embodiment of the clutch of the present invention with the clutch pack in its uncompressed state; and

FIG. 6 is perspective view of a another preferred embodiment of the present invention.

### DETAILED DESCRIPTION OF THE PREFERRED EMBODIMENTS

The multi-plate clutch of the present invention overcomes many of the shortcomings of previously known multi-plate clutch configurations to provide longer service life and quieter operation. The inclusion of a specially dimensioned drive plate, referred to herein as a stabilizer plate, in combination with conventional drive plates serves to rotationally stabilize the entire clutch pack without impeding the clutching and declutching operations. By stabilizing the relative rotational movements of interacting components, the force of the impacts between the engaging surfaces of such components is greatly reduced to yield a commensurate reduction in damage and wear that would otherwise invariably result with use. The reduction in impact forces additionally serves to reduce the hammering noise that would otherwise be generated.

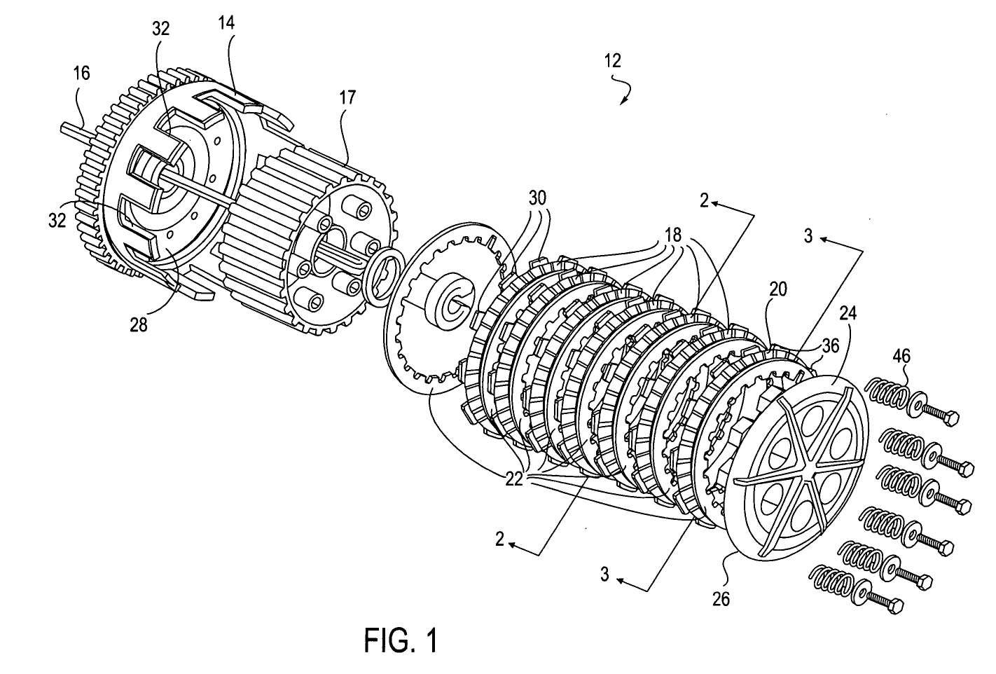

FIG. 1 is an exploded perspective view of a preferred embodiment of the present invention. The multi-clutch 12 serves to interruptably transfer torque between for example an engine (not shown) that is rotationally coupled to the clutch's outer shell 14 and an transmission (not shown) that is rotationally coupled to the clutch's output shaft 16. Power transfer is achieved by the compression of an alternating sequence of coaxially arranged drive plates 18, including one specially dimensioned drive plate 20 (hereinafter referred to as a stabilizer plate), and driven plates 22 against one another wherein the drive plates are rotationally coupled to the shell while the driven plates are rotationally coupled to the output shaft via a carrier 17. Although the clutch pack that is shown in this particular illustration includes of a total of seven drive plates and eight driven plates, the present invention can be adapted to clutch packs with higher or lower plate counts. Compression of the clutch pack is accomplished by the action of a pressure plate 24 that is disposed at one end of the shell. A spring-loaded engaging surface 26 that extends therefrom serves to force the entire clutch pack 18, 20, 22 against another engaging surface 28 that is disposed on the opposite end of the shell to thereby cause adjacent plate faces to tightly engage one another. Release of the plates from engagement is achieved by countering the spring force generated by the pressure plate with an actuation mechanism such as the foot operated hydraulic mechanism typically employed in automotive applications or the hand operated mechanism typically employed in motorcycle applications.

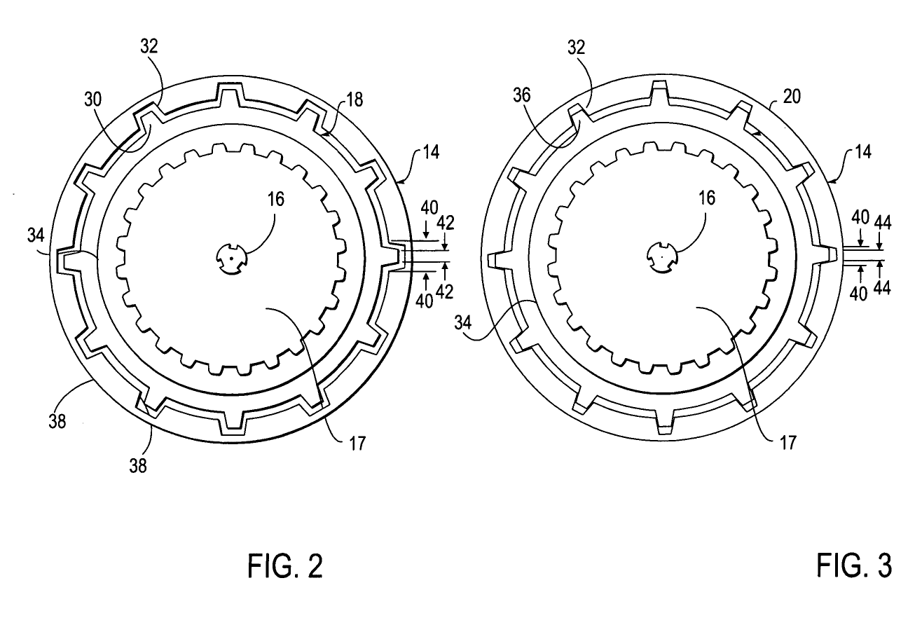

FIG. 2 is a cross-sectional view taken along lines 2-2 in FIG. 1. The drive plate 18 is rotationally coupled to the outer shell 14 by keys 30 that extend radially from the periphery of the drive plate that are received in channels 32 formed in the interior surface of the outer shell. While a configuration with a total of twelve keys for receipt in twelve channels is shown for illustration, the present invention is readily adaptable to clutch configurations relying on any number, shape and placement of keys. The channels formed in the inner surface of the outer shell 14 may be of any depth including extension completely there through. The engaging surface 34 is configured to frictionally engage a similarly configured engaging surface of an adjacent driven plate. The gaps 38 that are shown between the edges of the keys and the sidewalls of the channel are exaggerated for illustrative purposes. Nonetheless, the width 42 of the keys are selected to be significantly less than the width 40 of the channels in order to ensure that the drive plates are free to shift axial along the channels during the clutching and declutching operations. The actual widths and actual differences in the widths is of course dependent upon the particular clutch configuration and application.

FIG. 3 is a cross-sectional view taken along lines 3-3 in FIG. 1. The stabilizer plate 20 is rotationally coupled to the outer shell 14 by keys 36 that extend radially from the periphery of such drive plates that are received in channels 32 formed in the interior surface of the outer shell. The engaging surface 34 is configured to frictionally engage a similarly configured engaging surface of an adjacent driven plate. While the stabilizer plate has the same configuration as the drive plate 18, the plates are differentiated in terms of the dimensions of certain features. More particularly, the keys have a width 44 that more closely corresponds to the width of the channels 32. Consequently, essentially no gap is shown between the edges of the keys and the channels. The actual widths and actual differences in the widths is of course dependent upon the particular clutch configuration and application. Essential to the present invention is that the gaps between the keys 36 of the stabilizer plate 20 and the channels 32 are selected to be significantly less than the gaps between the keys 30 of the drive plates 18 and such channels. A stabilizer plate wherein the difference between the widths of its keys and the width of the channel is half as great as the difference between the width of the keys of other drive plates and the channels may yield the desired rotational stability without compromising clutch operation in some applications. A much greater difference in gap widths may be effective in other applications. For example, a difference in widths of a about 1:20 has been found to be effective in the clutch of a Ducati® 996 or 999, wherein stabilizer plate with a gap of only 0.001″ cooperates with the other drive plates which are dimensioned to have gaps of about 0.020″.

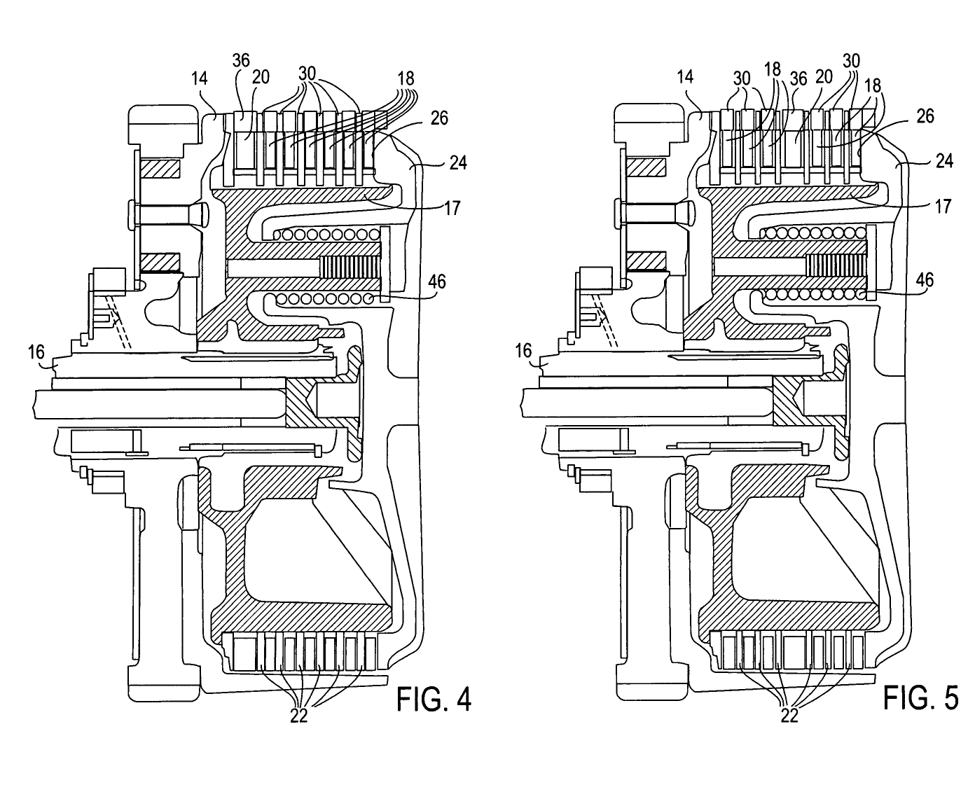

FIG. 4 is a longitudinal cross-sectional view of an alternative embodiment of the present invention in which the stabilizer plate 20 is differentiated from the other drive plates 18 not only in terms of the widths of its keys 36, but also in terms of the thickness of the entire plate including the keys. Increasing the thickness of the keys has been found to be most advantageous as it provides for more contact area between the keys and the channel to thereby enhance the stabilizer plate's torque transfer capability. Additionally, an overall thicker stabilizer plate serves to prevent flexure or distortion of the plate in general and the keys in particular which may otherwise cause the tightly dimensioned keys to bind or jam in their respective channels. A thicker stabilizer plate also serves to increase longevity by holding a closer tolerance longer. It has been found that doubling the thickness of the stabilizer plate is most effective and can be accommodated in many clutch configurations without further modification. An additional variation is shown relative to FIG. 1 in terms of the placement of the stabilizer plate vis-à-vis the other drive plates. While the stabilizer plate is positioned on the pressure plate 24 side of the clutch pack in the embodiment shown in FIG. 1, the embodiment shown in FIG. 4 has the stabilizer plate positioned on the opposite side of the clutch pack. It should be noted that FIG. 4 additionally serves to show the clutch in its compressed state wherein springs 46 associated with the pressure plate urges its engaging surface 26 against the clutch pack to cause all adjacent surfaces to be fully engaged.

FIG. 5 is a longitudinal cross-sectional view of yet another embodiment wherein the stabilizer plate 20 is positioned in the center of the clutch pack. Although, the stabilizer plate of the present invention has been found to be effective regardless of where it is positioned in the clutch pack, it has been found to be most effective when positioned nearest one of the ends of the clutch pack and most preferrably directly adjacent the pressure plate. It should also be noted that FIG. 5 additionally serves to show the clutch in its uncompressed state wherein springs 46 have been compressed to cause all adjacent engaging surfaces to disengage and to thereby interrupt the transfer of torque between the outer shell 14 and the output shaft 16.

In use, a stabilizer plate 20 with its tighter key dimensions, and optionally a greater thickness, is initially included in a clutch pack or is substituted for one of the drive plates 18 in an existing clutch pack. Release of a clutch pedal or clutch lever causes the pressure plate 24 to compress the clutch pack. As the engaging surfaces between the adjacent drive plates and driven plates engage, the drive plates cause the driven plates to spin up to speed. The initial acceleration of the driven plates 22 exerts a drag on the drive plates 18, 20 which causes the latter to rotate relative the outer shell 14 until the keys 30, 36 engage the sidewalls of the channels 32. Since the gap between the keys 36 of the stabilizer plate 20 and the channels' 32 sidewalls is minimal, engagement occurs almost immediately giving the plate a commensurately minimal time to accelerate relative to the outer shell to thereby minimize any speed differential. The minimal speed differential in turn minimizes the force of the impact between its keys 36 and the channel 32. This effect is propagated throughout the clutch pack as the clutch plate 22 immediately adjacent to the stabilizer plate along with the output shaft and all of the other driven plates is thereby more quickly brought up to speed which in turn lessens the drag on the drive plates 18 which in turn reduces the force with which the respective keys 30 impact the sidewalls of the channels. Any reversal in the direction of torque transfer causes a similar sequence of events. Because the stabilizer plate is essentially locked to the outer shell, any differential rotation between the other drive plates and the outer shell requires that friction between the stabilizer plate and the adjacent driven plates must first be overcome. Nonetheless, the operation of the clutch is not in any way compromised as the relatively large gap between the keys 30 of the drive plates 18 and the channels allows the plates to shift axially slightly within the channels as is required during both the clutching and declutching sequence while the greatly reduced gaps between the keys 36 of the single stabilizer plate and the channels has been found not to impede such movements. Such clutch configuration has been found to all but eliminate the hammering noises that are normally generated by multi-plate dry clutches, greatly reduce the rate of wear on the engaging surfaces and results in easier, smoother shifting between gears. Hard chroming the engaging surfaces of the keys and shell could be relied upon to further reduce the rate of wear.

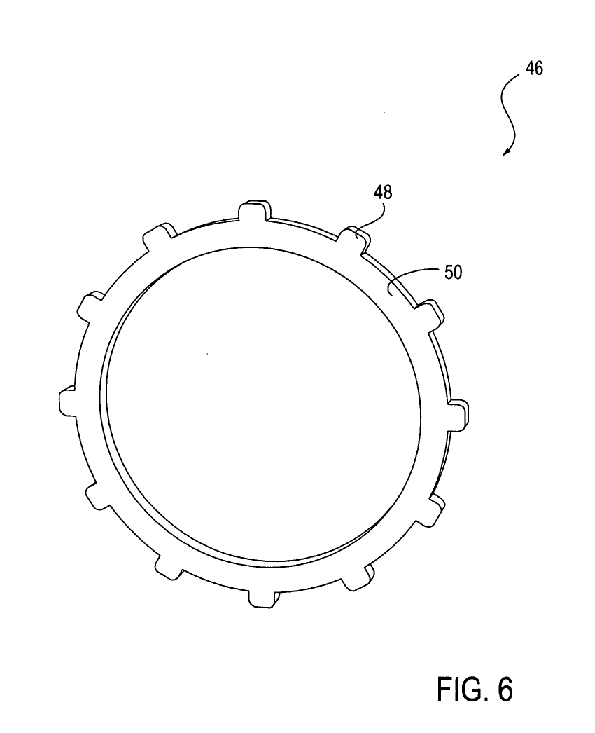

FIG. 6 is a perspective view of the stabilizer plate 46 of the present invention for use in a Ducati® 996 or 999 clutch. The plate has a total of twelve keys 48, each 0.490″ in width. The other drive plates that are used in conjunction with this stabilizer plate each have a key width of 0.476-0.480″. The engaging surface 50 has an inner diameter of 4.5″ and an outer diameter of 5.49″. The entire plate including its keys has a thickness of 0.12″.

The present invention can be adapted to any of a number of different clutch configurations in use today. In addition to “dry” applications, the invention is readily adaptable to “wet” configurations wherein the entire clutch pack is immersed in an oil to further dampen impacts between engaging surfaces. Moreover, the present invention can be adapted to clutches for use in conjunction with any of a variety of manual transmissions as well as to clutches that are used within some automatic transmissions wherein multi-plate clutch packs perform a similar function. It should also be noted the invention can readily be adapted for use in multi-plate braking systems such as are in use in aircraft wherein torque is transferred between rotating wheels and stationary brake discs.

Finally, it should be noted that the present invention can also be practiced by differentiating channel width rather than key width. Channels having a stepped width, wherein a reduced width is limited to an area of the channels that are exclusively contacted by the keys of a single one of a series of identical drive plate, would serve the same purpose. Alternatively, a set of channels with a reduced width can be dedicated to the keys of a single one of a series of identical plates wherein the channels of reduced width and the channels of nominal width are rotationally offset from one another. As a further alternative, a completely different coupling mechanism may be relied upon to rotationally couple the stabilizer plate to the shell so as to achieve the desired reduction in rotational play. It is also conceivable that the stabilizer plate may be rotationally coupled directly to the pressure plate in an appropriate multi-plate clutch configuration in which the pressure plate is linked to the shell in order to achieve the desired rotational stabilization while the clutch pack is in its compressed state.

While a particular form of the invention has been illustrated and described, it will also be apparent to those skilled in the art that various modifications can be made without departing from the spirit and scope of the invention. More particularly, the present invention can readily be adapted to a number of other multi-plate configurations including, for example, wherein the drive plates are coupled to a centrally disposed carrier while the driven plates are coupled to an outer shell. Additionally, the present invention covers any permutation of which plates are made of steel and which plates are made or layered with a friction material. Accordingly, it is not intended that the invention be limited except by the appended claims.

What is claimed is:

1. A multi-plate clutch for interruptably transferring torque between a first and second rotatable component, comprising:
an internal shaft rotationally coupled to said first component;
a plurality of first plates each concentrically arranged along said shaft and rotationally coupled thereto;
a cylindrical shell rotationally coupled to said second rotatable component and concentrically arranged around said first plates and shaft;
a plurality of second plates concentrically arranged along said shaft in an alternating sequence relative to said first plates and rotationally coupled to said shell so as to provide for a first amount of rotational play relative to said shell;
a third plate concentrically arranged along said shaft and rotationally coupled to said shell so as to provide for a second amount of rotational play relative to said shell, wherein said second amount of play is less than said first amount of rotational play; and
means for compressing said first, second and third plates against one another to enable a transfer of torque between said first and second component.

2. The clutch of claim 1, wherein said first amount of rotational play is approximately 20 times greater than said first amount of rotational play.

3. The clutch of claim 1, wherein said third plate is positioned at one end of said sequence of second plates.

4. The clutch of claim 1, wherein said first component comprises a transmission and said second component comprises an engine.

5. The clutch of claim 1, wherein said plates are not immersed in a liquid.

6. The clutch of claim 1, wherein said plates are immersed in a liquid.

7. A multi-plate clutch for interruptably transferring torque between a first and second rotatable component, comprising:
an internal shaft rotationally coupled to said first component;
a plurality of first plates each concentrically arranged along said shaft and rotationally coupled thereto;
a cylindrical shell rotationally coupled to said second rotatable component and concentrically arranged around said first plates and shaft, said shell having axially arranged channels formed therein, each channel having a first width;
a plurality of second plates concentrically arranged along said shaft in an alternating sequence relative to said first plates and rotationally coupled to said shell, wherein said second plates have keys extending radially therefrom configured for receipt in said channels and wherein such keys each have a second width, wherein said second width is less than said first width;
a third plate concentrically arranged along said shaft and rotationally coupled to said shell, wherein said third plate has keys extending radially therefrom configured for receipt in said channels and wherein such keys have a third width, wherein said third width is greater than said second width and less than said first width; and
means for compressing said first, second and third plates against one another to enable a transfer of torque between said first and second component.

8. The clutch of claim 7, wherein the difference between said first and second width is about 20 times as large as the difference between said first and third width.

9. The clutch of claim 7, wherein the keys of said third plate are approximately twice as thick as the keys of said second plates.

10. The clutch of claim 7, wherein said third plate is positioned at one end of said sequence of second plates.

11. The clutch of claim 7, wherein said first component comprises a transmission and said second component comprises an engine.

12. The clutch of claim 7, wherein said plates are not immersed in a liquid.

13. The clutch of claim 7, wherein said plates are immersed in a liquid.

14. A multi-plate clutch for interruptably transferring torque between a first and second rotatable component, comprising:
an internal shaft rotationally coupled to said first component;
a plurality of first plates each concentrically arranged along said shaft and rotationally coupled thereto;
a cylindrical shell rotationally coupled to said second rotatable component and concentrically arranged around said first plates and shaft, said shell having axially arranged channels formed therein, each channel having a width;
a plurality of second plates concentrically arranged along said shaft in an alternating sequence relative to said first plates and rotationally coupled to said shell, wherein said second plates have keys extending radially therefrom configured for receipt in said channels and dimensioned so as to allow some rotational play therein;
a third plate concentrically arranged along said shaft and rotationally coupled to said shell, wherein said third plate has keys extending radially therefrom configured for receipt in said channels and dimensioned so as to allow substantially less rotational play therein than said second plates; and
means for compressing said first, second and third plates against one another to enable a transfer of torque between said first and second component.

15. The clutch of claim 14, wherein said rotational play of said third plate is about 5% of the rotational play of said second plates.

16. The clutch of claim 14, wherein the keys of said third plate are approximately twice as thick as the keys of said second plates.

17. The clutch of claim 14, wherein said third plate is positioned at one end of said sequence of second plates.

18. The clutch of claim 14, wherein said first component comprises a transmission and said second component comprises an engine.

19. The clutch of claim 14, wherein said plates are not immersed in a liquid.

20. The clutch of claim 14, wherein said plates are immersed in a liquid.

21. A stabilizing plate for substitution for one of a series of identical drive plates in a multi-plate clutch device that each have a configuration so as to be rotationally coupled to and axially shiftable relative to a surrounding shell component by keys that extend radially from each drive plate for receipt in axially extending channels formed in the shell component, wherein such keys are dimensioned so as to loosely fit within said channels to allow for a preselected amount of rotational play of each of said drive plates relative to said shell, wherein said stabilizing plate comprises a plate that has the same configuration as each of said series of identical drive plates while its keys are dimensioned so as to substantially more tightly fit within said channels to limit the rotational play of said stabilizer plate relative to said shell to substantially less than said preselected amount of rotational play.

22. The stabilizing plate of claim 21, wherein said rotational play of said stabilizer plate is less than about ½ of said rotational play of each of said series of drive plates.

23. The stabilizing plate of claim 22, wherein said rotational play of said stabilizer plate is about 1/20 of said rotational play of each said series of drive plates.

24. The stabilizing plate of claim 21, wherein said keys of said stabilizer plate are thicker than said keys of each of said series of identical drive plates.

25. The stabilizing plate of claim 24, wherein said keys of said stabilizer plate are about twice as thick as said keys of each of said series of identical plates.

26. The stabilizer plate of claim 23, wherein said keys of said stabilizer plate are about twice as thick as said keys of each of said series of identical plates.
